(19) United States
(12) Patent Application Publication
(10) Pub. No.: US 2005/0187920 A1
(43) Pub. Date: Aug. 25, 2005

(54) Contextual searching

(75) Inventors: Samuel Sergio Tenembaum, Punta Del Este (UY); Daniel San Pedro, Buenos Aires (AR); Abel Gordon, Haifa (IL)

Correspondence Address: DARBY & DARBY P.C., P. O. BOX 5257, NEW YORK, NY, 10150-5257, US

(73) Assignee: Porto Ranelli, SA, Punta Del Este (UY)

(21) Appl. No.: 11/041,002

(22) Filed: Jan. 21, 2005

Related U.S. Application Data
(60) Provisional application No. 60/538,759, filed on Jan. 23, 2004.

(51) Int. Cl. G06F 17/30

(52) U.S. Cl. 707/3

(57) ABSTRACT

A method of improving the relevance of search results includes the steps of selecting search terms from a document under review for performing a search, and incorporating text surrounding the search terms in the document and the search terms into a query string. A search is then imitated using the expanded query string. As a result, the information retrieved depends not only on the search terms but also on the context in which they were found in the original document.

### CLAIM OF PRIORITY

This application claims the benefit of priority under 35 U.S.C. § 119(e) to U.S. Provisional Application No. 60/538,739, filed Jan. 23, 2004, titled “Contextual Searching,” hereby incorporated by reference in its entirety.

### FIELD OF THE INVENTION

The present invention relates generally to a method for improving the relevance of search results by considering the context of the query as well as its arguments.

### BACKGROUND OF THE INVENTION

As computers and networks grow and multiply, and as the amount of data being gathered and probed increases exponentially, search engines have become indispensable tools for most aspects of business.

Search engines turn vast reservoirs of meaningless data into invaluable information. It is the capability of these engines to separate the wheat from the chaff that powers the great databases of the world, which in turn power most information management systems: supply and demand, CRM, e-commerce, payroll, accounting, documentation, file management, customization, ad-serving and many other types of systems.

Search technology has become increasingly strategic for all aspects of business. It has become a formidable money-maker for various technology and media players on the internet, and is at the top of the priority list for companies like Microsoft, Google, Yahoo and AOL, among a myriad of other ventures of all sizes.

Search technology is at the heart of the commerce and culture revolution of our times, and as the volume of data and the number of queries grow, the importance of the relevance of those queries grows too. Relevant results are defined herein as “having some sensible or logical connection with something else, for example, a matter being discussed or investigated.” Hence, if what we are looking for are “relevant” results, and that means that they have a sensible or logical connection to something else, it becomes obvious that the “something else” has to be a consideration in the query.

Many initiatives and ideas aimed at improving the relevance of results have emerged in the last few years, the most influential and widely discussed of them being the Google search algorithm. By taking into consideration the number of links connecting to a given page, and the number of people who find it useful or interesting, Google tackled relevancy head on. Searches are no longer performed in a vacuum, they take into consideration earlier searches and connections between the data that were not considered previously.

The present application extends the contextual nature of the search by considering the context in which the search arguments where found.

### SUMMARY OF THE INVENTION

It is an object of the present invention to enhance the relevance of search results by considering additional data surrounding queried text. Preferably, this is achieved by delivering search functionality within other applications instead of as a text entry box with no relation to the context in which the query arguments are originally found.

Prior to the current invention, searches have been performed more or less in the following fashion:
The user reads an article and finds a word or string of words that he or she considers worthy of further investigation;
The user highlights the string of characters and copies it;
The user opens a search engine, usually a web based service, like Google or Yahoo; and
The user pastes the string of text into a query box and performs a search.

It becomes clear from the above description that the string that is used for the query is removed from its context and pasted into another application (or another website) before the search is performed. This removal from context hinders the search engine's ability to render relevant results, since relevance is by definition a function of context and context is no longer available.

To solve this problem, the present invention brings search capabilities to the original document, whether it is a web page, a Microsoft Word file, a database file or any other kind of data. Thus, it is possible to consider the text surrounding the selection.

Some embodiments of the current invention could achieve this by using “Shvitzer” technology, as disclosed in U.S. Provisional Application No. 60/517,586, the disclosure of which is incorporated herein by reference in its entirety. Such an embodiment allows the search function to be included in the contextual menu deployed by highlighting text on a web page.

One embodiment of the present invention is activated by dragging the selection onto a specific area of the screen.

Other embodiments take the functionality to the application level, adding it to menus or palettes, and empowering users to conduct searches directly from a specific application.

Another embodiment takes the form of a specialized application that is activated in any other program by use of macros or mouse/key combinations.

Alternatively, the current invention could be integrated at the operating system level, making the functionality available throughout the entire system.

In all embodiments, the current invention allows for the contextualization of the query string, so that the search engine can use contextual information to enhance the search itself.

It is contemplated that, in some embodiments of the present invention, the selected text could be submitted along with the surrounding text to the search engine, so as to keep the search in context. Other embodiments, like the currently preferred one, could use any of the widely available web based search engines to refine the examination in a succession of individual searches that are defined by an algorithm. This embodiment benefits from the fact that any search engine can be used, without the need for modifying it. A currently preferred embodiment uses Google as the search engine.

Those skilled in the art will realize that considering the surrounding sentence and paragraph in addition to the selected text allows for a number of variations in the search algorithm in order to customize and tweak the results of the search.

Those skilled in the art will also appreciate that the invention is not limited to the use of a single search engine, but may make use of multiple search engines simultaneously, applying a contextualization algorithm to the various results returned.

### BRIEF DESCRIPTION OF THE DRAWINGS

The foregoing brief description, as well as further objects, features, and advantages of the present invention, will be understood more completely from the following detailed description of a presently preferred, but nonetheless illustrative embodiment, with reference being had to the accompanying drawing, in which;

FIG. 1 is an illustration of a user computer in the process of conducting a search over the internet for particular content according to the present invention; and

FIG. 2, made up of FIGS. 2A, 2B and 2C, is a flowchart illustrating a preferred contextualization algorithm for practicing the present invention.

### DETAILED DESCRIPTION OF THE PREFERRED EMBODIMENT

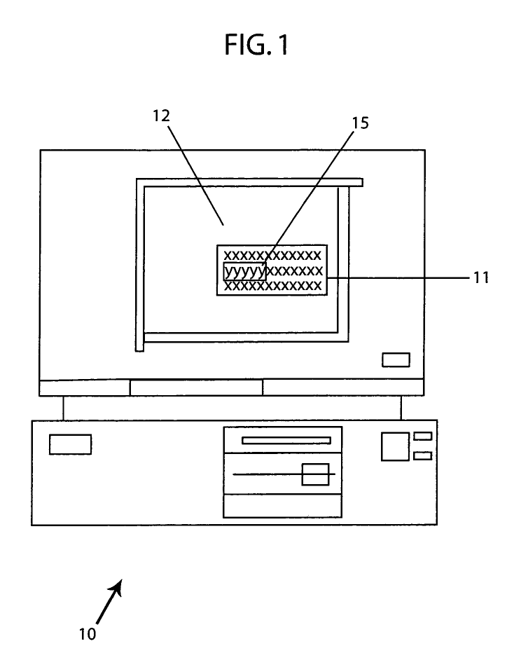

FIG. 1 shows a user at a terminal of a computer 10 reviewing on its display 12 a document 11 that has been retrieved. As shown, there is a key word in 15 which the user is interested and about which he wants additional information. The user highlights the word or words of interest, and then blocks and copies the paragraph that contains the word into an especially designed web browser. The browser performs the search on the keyword as well as the context in which it is found in the sentence.

The following nomenclature is utilized in the following description:
Selection: a word or words to be searched.
Sentence: a sentence containing the selection.
Paragraph: a paragraph containing the sentence.

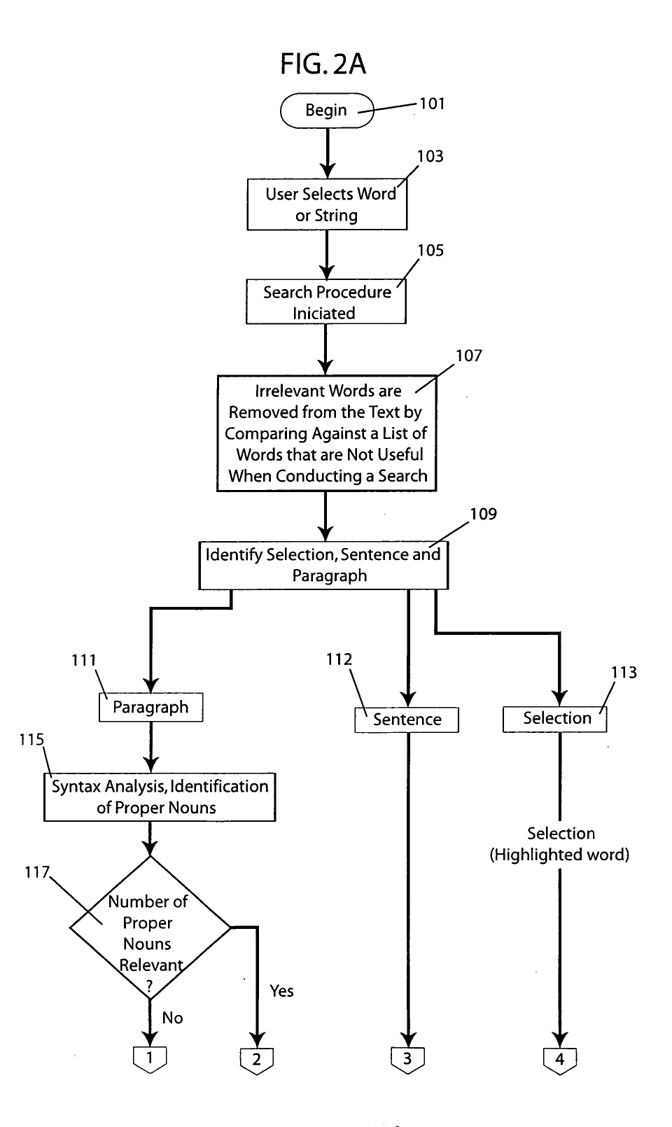

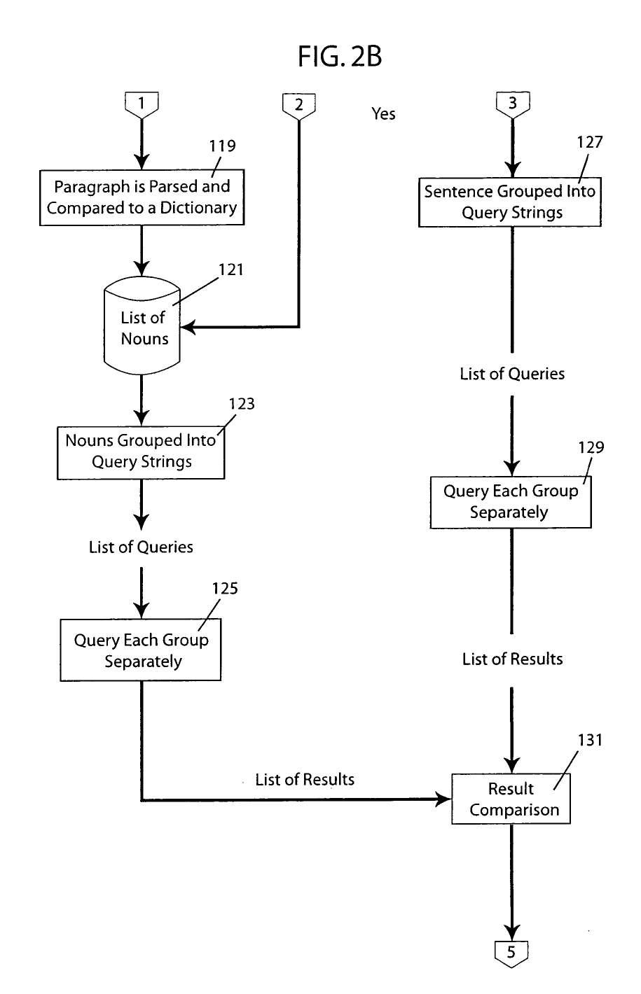

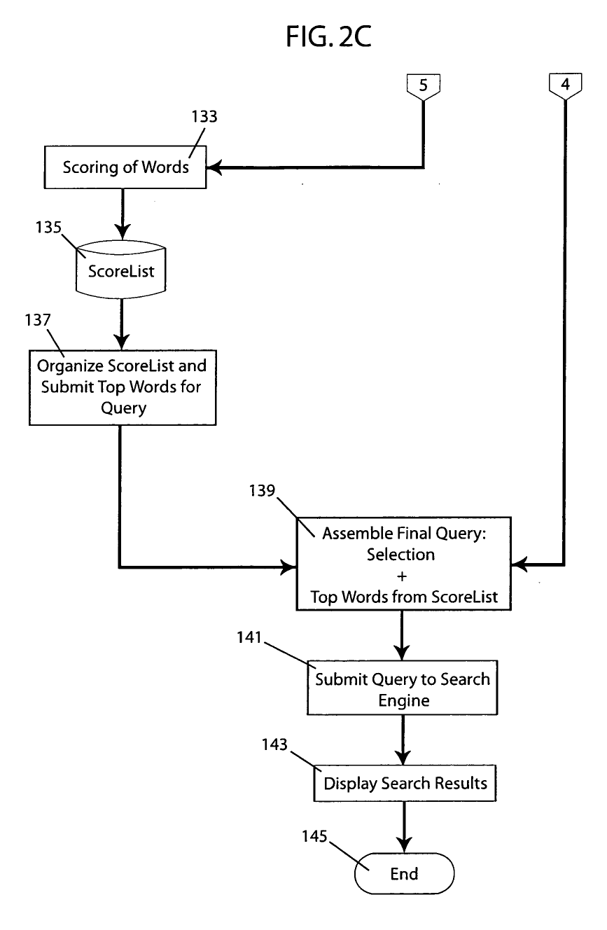

The logic flow described in FIG. 2 starts at block 101. Block 103 depicts the selection process performed by the user, i.e., the process by which the user selects words or phrases about which he wants additional information. Users may select single or multiple words. After the user makes a selection, the search procedure is started at block 105, either automatically (as with Shvitzer technology), by dragging the selection onto an icon, or via a menu or a palette or a browser.

The process continues at block 107, where the text in its entirety (or just the paragraph) is compared with a list of words that should not be considered in the analysis. These are words that are considered irrelevant for a number of reasons (e.g., prepositions and articles). Next, at block 10, the paragraph, the sentence and the selection are identified and each is subjected to a different path of analysis, as seen in blocks 111, 112 and 113.

The paragraph analysis begins at block 111 and goes on to block 115, where the syntax is examined and proper nouns are identified. The number of proper nouns is considered at block 117, if they exceed a predetermined amount then flow jumps to block 121, otherwise block 119 identifies all common nouns in the paragraph and adds them to the list of proper nouns already identified in block 115. The process resumes at block 121, where a list of nouns is compiled. The list includes only proper nouns or all nouns in the paragraph, depending on the whether the number of proper ones does or does not exceed the predetermined figure.

Block 123 represents the process by which the list of nouns is divided into groups. The number of words per group may vary. Each group is passed on to block 125, where they are submitted to a search engine as separate queries. The process then merges onto the sentence analysis branch at block 131.

The sentence analysis branch begins at block 127, continuing from block 112. Block 127 groups the words of the sentence into query strings of a few words each. The list of query strings is passed on to block 129, where they are submitted to a search engine separately. The list of results from the individual queries is then compared to the list of results from the paragraph analysis. This takes place at block 131. Words that appear on both lists of results are passed on to block 133, where each word is assigned a score (based on whether it is a proper noun, how many times it appears, how close to the selection it is found, how often it was queried before, etc.), and then organized in a list in block 135.

Next, at block 137, the top words from the list are sent to block 139. Block 139 merges the result of the above process with the original selection coming directly from block 113, and it assembles a query with the selection plus the top words from the paragraph and sentence analyses. Next, at block 141, the query is submitted to a search engine, which returns its results at block 143. The process ends at block 145.

Depending on the embodiment, the selected text could be submitted along with the surrounding text to the search engine, so as to keep the search in context. This, of course, would required an especially designed browser that would parse the text into paragraphs, sentences and the selected keyword. In another embodiment, the selected text and surrounding text could be placed in any of the widely available web based search engines to refine the examination in a succession of individual searches that are defined by an algorithm. This embodiment benefits from the fact that any search engine can be used, without the need for modifying it. A currently preferred embodiment uses Google as the search engine.

Those skilled in the art will realize that considering the surrounding sentence and paragraph in addition to the selected text allows for a number of variations in the search algorithm in order to customize and tweak the results of the search.

Although preferred embodiments of the invention have been disclosed for illustrative purposes, those skilled in the art will appreciate that many additions, modifications and substitutions are possible, without departing from the scope and spirit of the invention.

1. A method of improving the relevance of search results comprising the steps of:
selecting search terms for performing a search;
incorporating text surrounding the search terms and the search terms into a query string; and
initiating a search using the query string, wherein the search is based on the search terms and related key terms in the surrounding text.

2. The method of claim 1, wherein the step of initiating a search includes the steps of separating the surrounding text into sentences and searching the sentences as well as the search terms.

3. The method of claim 2, wherein the step of incorporating involves including in the query string a full sentence in which the search terms were found.

4. The method of claim 1, wherein the step of incorporating involves including in the query string part of a paragraph in which the search terms was found.

5. The method of claim 1, wherein the step of incorporating involves including in the query string a full paragraph in which the search terms was found.

6. The method of claim 1, wherein the step of incorporating involves including in the query string part of a document in which the search terms were found.

7. The method of claim 1, wherein the step of incorporating involves includiong in the query string a full document in which the search terms were found.

8. The method of claim 1, wherein the step of initiating the search involves including a search function in a contextual menu deployed by highlighting text on a web page.

9. The method of claim 1, wherein the step of initiating the search involves dragging search terms and context to a specific area.

10. The method of claim 1, wherein the step of initiating the search involves building a search function at the application level, thus enabling contextual searches of documents created and edited by the application.

11. The method of claim 1 wherein the step of initiating the search comprises the steps of;
identifying the selected search terms; sentences in the surrounding text and paragraphs in the surrounding text;
identifying the proper nouns in the paragraph and their number;
create a list of proper nouns identified in the paragraph;
group the proper nouns in the list into query strings;
search each group separately and obtain paragraph search results;
group the words of each sentence into query strings;
search each sentence query string separately and obtain sentence search results;
compare the paragraph search results and the sentence search results to obtain a list of words common to each;
score each common word in the compare list based on predetermined criteria;
select a certain number of the highest scoring words and combine them with the selected search terms; and
perform a search on the combined highest scoring words and the selected search tems to obtain the results.

12. The method of claim 11 wherein the predetermined criteria is based on one or more of whether the word is a proper noun, how many times it appears, how close to the selection it si found, and how often it was queried before.

13. The method of improving the relevance of search results by incorporating context of the search terms as part of the query string, comprising the steps of:
establishing a selection process performed by a user;
selecting one or more words to use in a search inquiry;
initiating search procedure;
predetermining a list of words that will be excluded from consideration in the analysis portion of a search;
comparing a portion of the text with the excluded pre-identified words;
removing matched words from further consideration in the analysis of a search; and
identifying the selected words to use in a search query as being one of a paragraph, a sentence or a selection.

14. The method of claim 13, further comprising the step of:
identifying the selected words as a paragraph;
predetermining the number of proper nouns acceptable in a search;
examining the syntax of the paragraph and identifying proper nouns within the paragraph;
comparing the number or proper nouns with the paragraph to the number of proper nouns acceptable in a search;
compiling a list of nouns;
grouping the list of nouns into query strings; and
submitting the query strings to search engines as separate queries;

15. The method of claim 14, further comprising the step of:
etermining that the number of proper nouns in the paragraph exceed the number of the proper nouns acceptable in a search; and
transmitting the exceeding proper nouns to a list of compiled nouns.

16. The method of claim 14, further comprising the step of:
determining that the number of proper nouns in the paragraph does not exceed the number of the proper nouns acceptable in a search;
identifying all common nouns in a paragraph; and
adding them to the list of proper nouns previously identified.

17. The method of claim 13, further comprising the step of:
identifying the words as a sentence;
grouping the [words] of the sentence into query strings; and
submitting the query strings separately to a search engine.
